(19) United States
(12) Patent Application Publication
(10) Pub. No.: US 2025/0117452 A1
(43) Pub. Date: Apr. 10, 2025

(54) SYSTEMS AND METHODS FOR SECURING AND STORING CONTENT

(71) Applicant: Capital One Services, LLC, McLean, VA (US)

(72) Inventors: Joshua EDWARDS, Philadelphia, PA (US); Tyler MAIMAN, Melville, NY (US); Ian KATZMAN, Herndon, VA (US); Shahalam BAIG, Rochester, NY (US); Jackson WESTWOOD, New York, NY (US); Shasanka BHANDARI, McLean, VA (US); Matthew HUNSBERGER, Hoboken, NJ (US); David WEEKLY, Redwood City, CA (US)

(73) Assignee: Capital One Services, LLC, McLean, VA (US)

(21) Appl. No.: 18/905,167

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10

(52) U.S. Cl. CPC G06F 21/106

(57) ABSTRACT

A method may include receiving, using a browser module of a computing device, a first webpage, wherein the first webpage is associated with a content element. The method may include receiving, using the browser module, a video, wherein the video is associated with the content element and a digital rights management technology. The method may include forming, using the browser module, an HTML element including the video. The method may include outputting, using the browser module, at least a portion of the first webpage to a display screen. The method may include outputting, using an operating system of the computing device, the video of the HTML element to the display screen, wherein the video is configured to be overlaid on the at least a portion of the first webpage on the display screen. The method may include storing, using a storage component of the computing device, the outputted video.

### CROSS-REFERENCE TO RELATED APPLICATION(S)

This application claims the benefit of pending U.S. Provisional Patent Application No. 63/587,891, filed on Oct. 4, 2023, and claims the benefit of pending U.S. Provisional Patent Application No. 63/665,485, filed on Jun. 28, 2024, and claims the benefit of pending U.S. Provisional Patent Application No. 63/683,063, filed Aug. 14, 2024, each of which is incorporated herein by reference in its entirety.

### TECHNICAL FIELD

Various embodiments of this disclosure relate generally to techniques for securing content, and more particularly to systems and methods for securing and storing content of a portal (e.g., a webpage, a website, an application, or the like).

### BACKGROUND

Organizations such as banks and healthcare providers seek to protect information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and to then transmit the screenshot to the social engineer.

To guard against such social engineering, the bank may employ digital rights management (“DRM”) technologies, which are technologies that limit the use of digital content. For example, the bank may cause the user's display screen to present one or more videos that are protected using DRM technologies. However, the generation, loading, and playing of these videos may require significant processing resources. Further, where image frames (or video frames) of the one or more videos represent interactive features (e.g., buttons or text boxes), the user may not be able to interact with these elements when the one or more videos are played on the display screen. In addition, the bank may wish to further enhance the security of content presented on the bank's website.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing and storing content of a portal (e.g., a webpage, a website, an application, or the like) are disclosed. Each of the examples disclosed herein may include one or more features described in connection with any of the other disclosed examples.

In one aspect, an exemplary embodiment of a method may include receiving, using a browser module of a computing device, a first webpage of a website from an application server. The first webpage may be associated with a content element. The method may include receiving, using the browser module, a video from the application server, where the video is associated with the content element and a digital rights management technology. The method may include forming, using the browser module, a HyperText Markup Language (HTML) element including the video. The method may include outputting, using the browser module, at least a portion of the first webpage to a display screen associated with the computing device. The method may include outputting, using an operating system of the computing device, the video of the HTML element to the display screen, where the video is configured to be overlaid on the at least a portion of the first webpage on the display screen. The method may further include storing, using a storage component of the computing device, the outputted video.

In a further aspect, an exemplary embodiment of a system may include at least one processor and at least one memory having programming instructions stored thereon, which, when executed by the at least one processor, cause the system to perform operations. The operations may include receiving, using a browser module of a computing device, a first webpage of a website, where the first webpage is associated with a content element. The operations may include receiving, using the browser module, a video associated with the content element and a digital rights management technology. The operations may include forming, using the browser module, a HyperText Markup Language (HTML) element including the video. The operations may include outputting, using the browser module, at least a portion of the first webpage to a display screen associated with the computing device. The operations may include outputting, using an operating system of the computing device, the video of the HTML element to the display screen, where the video is configured to be overlaid on the at least a portion of the first webpage on the display screen. The operations may further include storing, using a storage component of the computing device, the outputted video.

In another aspect, an exemplary embodiment of a method may include receiving, using a browser module of a computing device, a first webpage of a website, wherein the first webpage is associated with a content element. The method may include receiving, using the browser module, a video associated with a digital rights management technology and including an image frame that represents the content element. The method may include forming, using the browser module, a HyperText Markup Language (HTML) element including the video. The method may include outputting, using the browser module, at least a portion of the first webpage to a display screen associated with the computing device. The method may include outputting, using an operating system of the computing device, the video of the HTML element to the display screen, where the video is configured to be overlaid on the at least a portion of the first webpage on the display screen. The method may further include storing, using a cache of the computing device, the outputted video.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3A depicts an example browser window, according to one or more embodiments.

FIG. 3B depicts an example browser window, according to one or more embodiments.

FIG. 4A depicts an example browser window, according to one or more embodiments.

FIG. 4B depicts an example browser window, according to one or more embodiments.

FIG. 5 depicts a flowchart of an example method, according to one or more embodiments.

FIG. 6 depicts a flowchart of an example method, according to one or more embodiments.

FIG. 7 depicts a flowchart of an example method, according to one or more embodiments.

FIG. 8 depicts a flowchart of an example method, according to one or more embodiments.

FIG. 9 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event].” depending on the context.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11, an application accessed using a Print Screen key of a keyboard or keypad, or the like).

As used herein, the term “sensitive information” may refer to data that is intended for, or restricted to the use of, one or more users or entities. Sensitive information may represent data that is personal, private, confidential, privileged, secret, classified, or in need of protection. Examples of sensitive information may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, alpha product releases, or business strategy information; governmental information such as classified or secret information related to national security or defense); or data that is copyrighted, etc.

As used herein, the terms “image frame that is transparent” and “transparent image frame” refer to an image frame of a video, where the image frame is clear (e.g., see-through or invisible, from the perspective of a user viewing the image frame on a display screen), and does not depict or represent any sensitive information.

In the following description, embodiments will be described with reference to the accompanying drawings. As will be discussed in more detail below, various embodiments, methods, and systems for securing and storing content of a portal (e.g., a webpage, a website, an application, or the like) are described.

In an exemplary use case, a customer of a bank may use a computing device (e.g., a laptop) to obtain financial information. More specifically, the customer may use a browser presented on a display screen of the computing device to load a first webpage that is associated with the bank, and on which the customer anticipates viewing the customer's checking account number and a hyperlink directed to a second webpage associated with the bank. In some aspects, the hyperlink may represent an interactive feature of the first webpage. Further, the checking account number may represent sensitive information. Sensitive information may refer to data that is intended for, or restricted to the use of, one or more users or entities (e.g., the customer and the bank).

As the webpage is loaded, an application server associated with the bank may generate a video that includes a single image frame, where the image frame represents or depicts the first webpage (including the checking account number and hyperlink). In some aspects, the video may be protected using a DRM technology, and be encrypted. Further, the video may be configured to play the image frame in a loop on the display screen of the computing device when the display screen is not being screenshared or screenshotted. The video may also be configured to not play (or be blocked from playing) the image frame on the display screen when the display screen is being screenshared or screenshotted, to prevent the checking account number from being shared with a social engineer or potential social engineer. In some aspects, the video may also be referred to herein as a “single frame-looped video.”

Once the video is generated and encrypted, the application server may transmit the encrypted video to a content decryption module (also referred to herein as a “CDM” or “DRM platform”), which may decrypt the encrypted video and transmit the decrypted video to the computing device. In some embodiments, the browser of the computing device may form an HTML element including the decrypted video, where the HTML element is a component of an HTML page that represents the first webpage associated with the bank. Further, where the display screen associated with the computing device is not being screenshared or screenshotted, an interactive video player of the computing device may play the decrypted video of the HTML element on the display screen. During the playing, the user may view the first webpage associated with the bank, including the user's checking account number and the hyperlink, on the display screen. The user may also select the hyperlink during the playing to navigate to the second webpage associated with the bank, where the user may, for example, transfer funds from the user's checking account to another account. In some embodiments, the second webpage may be included in an image frame of a DRM-protected video that may be played in a loop on the display screen, when the display screen is not being screenshared or screenshotted.

In some embodiments, the computing device may store the decrypted video played on the display screen to a local storage component of the computing device. Consequently, if, while viewing the second webpage, the user attempts to navigate back to the first webpage (e.g., by selecting a back button of the browser), the computing device may retrieve the video (including the image frame depicting the first webpage) from the local storage component and load the video to the display screen more quickly than if the computing device retrieved the video from the application server via the CDM. Accordingly, storing the video (including the image frame depicting the first webpage) in the local storage component of the computing device may help to conserve resources. In addition, for enhanced security, the computing device may be configured to block electronic copying (e.g., to an electronic clipboard) of the image frame depicting the first webpage when this image frame is played on the display screen, so that if a social engineer or potential social engineer took control of the computing device, the social engineer or potential social engineer could not readily copy the image frame depicting the first webpage (or the checking account number) and paste the copy of this image frame to an application for future use. Accordingly, the computing device may be used to protect the user's financial information from bad actors, while conserving resources and preserving the interactivity of the hyperlink on the first webpage.

While the example above involves a webpage and checking account number, it should be understood that techniques according to this disclosure may be adapted to any suitable type of program (e.g., a website, portal, application, browser extension, plugin, etc.) and data (e.g., sensitive information, non-sensitive information, text data, image data, audio data, etc.), respectively. It should also be understood that the example above is illustrative only. The techniques and technologies of this disclosure may be adapted to any suitable activity.

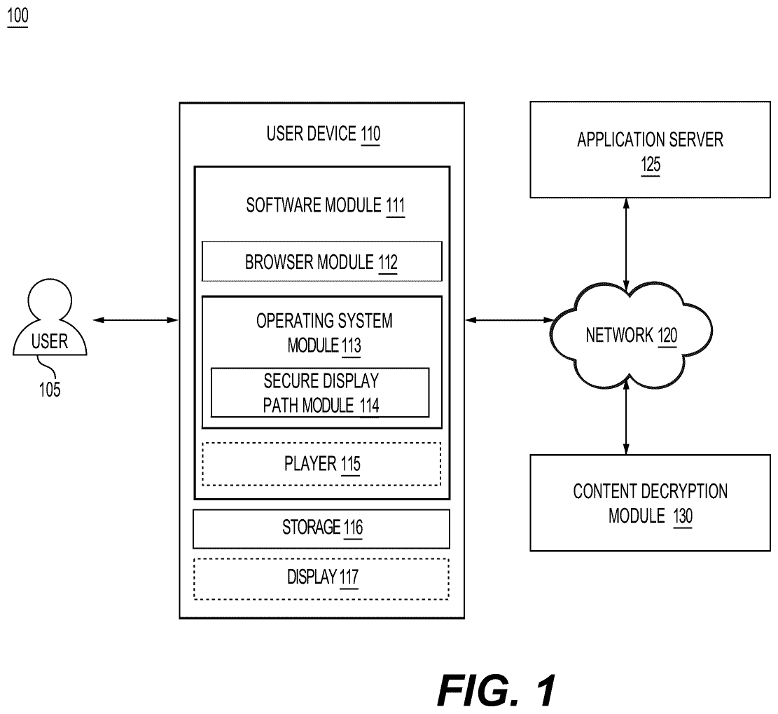

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed on Jun. 28, 2024, where each of these U.S. provisional applications is incorporated by reference herein in its entirety, or (iii) the environment 100 described in U.S. Provisional Patent Application No. 63/683,063, filed Aug. 14, 2024. As shown in FIG. 1, the environment 100 may include a user device 110, a network 120 (e.g., an electronic network), an application server 125, and a CDM 130. In some aspects, the user device 110, the application server 125, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal accessed using the user device 110.

The user device 110 may be configured to enable the user 105 to access or interact with the network 120, the application server 125, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 113, and optionally a player 115. The player 115 may represent a video player configured to play back one or more videos, or present image frames (or video frames) of one or more videos on a display screen. In some embodiments, the player 115 may be included in the browser module 112 or the operating system module 113 (not shown in FIG. 1). In some other embodiments, the player 115 may represent hardware included in the user device 110 (not shown in FIG. 1). In some embodiments, the player 115 may represent an interactive video player, which is a video player configured to play back a video, where a user (e.g., the user 105) may interact with the video (e.g., by selecting a button presented in the video) during the playback on a display screen. The user device 110 may also include a storage 116, which may represent a memory local to the user device 110, such as cache. In some aspects, the storage 116 may be configured to store (e.g., temporarily) data received from the browser module 112 or the operating system module 113. The storage 116 may also be configured to delete (or remove) data stored in the storage 116 (e.g., for security purposes or to conserve storage space). As shown in FIG. 1, the user device 110 may optionally include a display 117, which may represent a display screen configured to display or present data (optionally using the player 115), where the data may be received from the browser module 112 or the operating system module 113.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 113, the storage 116, the display 117, the network 120, and the application server 125 and the CDM 130, via the network 120. For example, in response to the user 105 inputting a web address (or uniform resource locator) to the browser module 112 (e.g., using the display 117 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage from the application server 125 via the network 120. In some aspects, the browser module 112 may be configured to load, render, or output the webpage (or a portion of the webpage) to the display 117 directly, or indirectly via the operating system module 113. The browser module 112 may also be configured to transmit the webpage (or at least a portion of the webpage, a DRM-protected video, or other data) to the storage 116 for storage, and to receive (or retrieve) the webpage from the storage 116.

In some aspects, the webpage received by the browser module 112 from the application server 125 may include one or more content elements (or represent a single content element). In some aspects, a content element may represent data such as text data (e.g., letters, numbers, symbols, metadata, or alt text), image data (e.g., an image, a graphic, a sequence of image frames, or a video), or audio data (e.g., a sequence of audio frames). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of an HTML page corresponding to (or representing) the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive information or non-sensitive information. As explained above, sensitive information may refer to data that is intended for, or restricted to the use of, one or more users or entities (e.g., the user 105 and an organization associated with the application server 125). Moreover, sensitive information may represent data that is personal, private, confidential, privileged, secret, classified, or in need of protection. Sensitive information may further represent, for example, financial data such as account numbers, credit card account numbers, checking account numbers, savings account numbers, virtual card numbers, account balances, credit card account balances, checking account balances, savings account balances, financial statements, ledgers, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense); or data that is copyrighted, etc.

In some embodiments, the browser module 112 may be configured to determine whether one or more content elements of the webpage include sensitive information. The browser module 112 may also be configured to transmit this determination to the application server 125 via the network 120. In some embodiments, the browser module 112 may be configured to receive one or more content elements of the webpage from the application server 125, optionally via the CDM 130. For example, the browser module 112 may be configured to receive a DRM-protected video that includes an image frame depicting the one or more content elements of the webpage, from the application server 125 via the CDM 130. The browser module 112 may also be configured to communicate with the operating system module 113 (e.g., via a secure display path module 114). For example, the browser module 112 may be configured to transmit one or more content elements (e.g., a DRM-protected video or other data) to the operating system module 113 (e.g., via the secure display path module 114).

Further, the browser module 112 may be configured to transmit one or more content elements (e.g., DRM-protected video(s), text data, image data, audio data, or the entirety of one or more webpages) to the storage 116 for storage. In some aspects, the browser module 112 may be configured to transmit the one or more content elements to the storage 116 before, during, or after, the one or more content elements are presented on the display 117. The browser module 112 may also be configured to retrieve the one or more content elements from the storage 116, for subsequent display on the display 117. In some aspects, because the one or more content elements (e.g., DRM-protected video(s)) may be presented on the display 117, stored in the storage 116, and then retrieved from the storage 116 for presentation once again on the display 117, resources may be conserved. For example, where the browser module 112 retrieves a DRM-protected video that was previously displayed on the display 117 from the storage 116, for subsequent display on the display 117, the previously displayed DRM-protected video does not have to be (i) re-generated and encrypted by the application server 125, (ii) transmitted from the application server 125 to the CDM 130 via the network 120, (iii) decrypted by the CDM 130, and (iv) transmitted from the CDM 130 to the browser module 112 via the network 120. Accordingly, processing resources of the application server 125 and CDM 130, and bandwidth of the network 120, may be conserved. Moreover, the browser module 112 may load a DRM-protected video more quickly if the DRM-protected video is retrieved from the storage 116 as opposed to being received from the application server 125 via the CDM 130.

In some aspects, the browser module 112 may be configured to detect an invalid action associated with a content element, where the content element may or may not be stored in the storage 116. An invalid action may represent an action that causes a content element to be invalid (e.g., not valid, out of date, incorrect, not useful, or warranting deletion or replacement in the storage 116). For example, in some embodiments, the browser module 112 may detect that a content element such as a credit card balance (or DRM-protected video including an image frame that depicts the credit card balance) is out of date responsive to receiving an indication from an application (e.g., a program, portal, or webpage) being executed on the user device 110 that the user 105 recently made a purchase using a credit card associated with the credit card balance. As another example, the browser module 112 may detect (or determine) that a content element such as a credit card balance is out of date responsive to receiving an indication from the application server 125 (e.g., a server associated with a bank who issued the user 105 a credit card associated with the credit card balance) that the user 105 recently made a purchase using the user 105's credit card. As another example, the browser module 112 may detect that a content element warrants deletion after a period of time elapses (e.g., where the period of time may be tracked or measured by a timer associated with a webpage, portal, or application). As yet another example, the browser module 112 may detect that a content element stored in the storage 116 (or all content elements stored in the storage 116) warrants deletion when the user 105 logs off (or exits) a webpage, application, or portal being executed on the user device 110. In some embodiments, the browser module 112 may be configured to monitor for an invalid action associated with a content element by communicating with (e.g., periodically transmitting an inquiry to and receiving a response from) a webpage, application, or portal being executed on the user device 110 (or a user interface presented on the display 117 of the user device 110) or the application server 125.

In some embodiments, in response to detecting an invalid action associated with a content element, the browser module 112 may determine whether the content element is stored in the storage 116. Upon determining that the content element is stored in the storage 116, the browser module 112 may transmit a request to the storage 116 to delete (or remove) the content element stored in the storage 116. In some embodiments, the browser module 112 may transmit a request for an updated (or current) content element (e.g., an updated credit card balance or a DRM-protected video that includes an image frame depicting the updated credit card balance) to a webpage, application, or portal being executed on the user device 110, or to the application server 125. Upon receiving the updated content element, the browser module 112 may transmit the updated content element to the storage 116 for storage (or replacement of the invalid content element, if not already deleted).

In some embodiments, the operating system module 113 may include one or more operating systems. In some aspects, an operating system may represent software configured to (i) manage hardware and software resources of the user device 110 or (ii) provide services for applications associated with the user device 110. In some embodiments, the operating system module 113 may include the secure display path module 114 (also referred to herein as the “secure display path 114”). In some aspects, the secure display path 114 may represent (or include) one or more DRM technologies (or DRM functions) used to protect or secure content element(s) that the secure display path 114 receives (or retrieves) from the browser module 112, the storage 116, the application server 125, or the CDM 130. The secure display path 114 may be native (or specific) to a respective operating system of the operating system module 113. In some embodiments, the secure display path 114 may represent Microsoft's Protected Media Path, for example.

In some aspects, the secure display path module 114 may be configured to load, render, or output to the display 117, one or more content elements of a webpage for presentation, optionally while the browser module 112 concurrently loads, renders, or outputs to the display 117, the remainder (or a portion of) of the webpage for presentation. For example, where a content element of a webpage represents a DRM-protected video and includes an image frame depicting sensitive information (e.g., a checking account balance), the secure display path module 114 may load, render, or output the DRM-protected video to the display 117 while the browser module 112 concurrently loads, renders, or outputs to the display 117, the remainder (or a portion) of the webpage (e.g., a portion of the webpage that excludes the DRM-protected video and the sensitive information). In some embodiments, the DRM-protected video may be presented over background color(s) of the remainder (or a portion) of the webpage, on the display 117. As another example, where a first content element of a webpage represents a DRM-protected video and includes an image frame that is transparent (and does not depict or represent sensitive information) and where a second content element of the webpage represents sensitive information (e.g., a checking account balance), the secure display path module 114 may load, render, or output the first and second content elements to the display 117, while the browser module 112 loads, renders, or outputs to the display 117, the remainder (or a portion) of the webpage. In some aspects, the first content element (the DRM-protected video) may be presented on top of (or be overlaid on) the second content element (the sensitive information) on the display 117, which may be overlaid on the remainder (or a portion) of the webpage. Further, when the first content element (the DRM-protected video) is played on the display 117 (e.g., when the transparent image frame of the DRM-protected video is played in a loop), the user 105 may view the second content element (the sensitive information) presented under the first content element (or the transparent image frame the DRM-protected video) on the display 117. As used herein, the terms “image frame that is transparent” and “transparent image frame” refer to an image frame of a video, where the image frame is clear (e.g., see-through or invisible, from the perspective of a user viewing the image frame on the display 117), and does not depict or represent any sensitive information.

In some aspects, the secure display path 114 may be configured to protect (or secure) one or more content elements by blocking or preventing the one or more content elements from being loaded, rendered, or output to or played on the display 117, when the display 117 is being screenshared (e.g., using a screensharing application or remote desktop application) or screenshotted (e.g., using a screenshotting application). For example, in some embodiments, the user 105 may view a DRM-protected video overlaid on a webpage on the display 117, and so long as the display 117 is not screenshared or screenshotted, the DRM-protected video may be played on the display 117. While the DRM-protected video is played, the user 105 may be able to see a content element (e.g., a credit card balance) that is either (i) represented in an image frame of the DRM-protected video or (ii) presented under a transparent image frame of the DRM-protected video. However, if the user 105 attempts to screenshare or take a screenshot of the display 117 with a social engineer (or potential social engineer), the secure display path 114 may cause the DRM-protected video to stop playing (or be blocked from playing) so that the social engineer (or potential social engineer) and the user 105 cannot see the content element.

In some aspects, the operating system module 113 (e.g., the secure display path 114) may be configured to transmit one or more content elements (e.g., DRM-protected video(s), text data, image data, audio data, or the entirety of one or more webpages) to the storage 116 for storage, optionally via the browser module 112. Further, the operating system module 113 may be configured to transmit the one or more content elements to the storage 116 before, during, or after, the one or more content elements are presented on the display 117. The operating system module 113 may also be configured to retrieve one or more content elements previously displayed on the display 117 from the storage 116, for subsequent display on the display 117, which may help conserve processing and network bandwidth resources, as described above with reference to the browser module 112.

In some embodiments, the operating system module 113 may be configured to detect an invalid action associated with a content element in a manner similar to that described above for the browser module 112. The operating system module 113 may also be configured to monitor for an invalid action associated with a content element by communicating with (e.g., periodically transmitting an inquiry to and receiving a response from) a webpage, application, or portal being executed on the user device 110 or the application server 125.

In some embodiments, in response to detecting an invalid action associated with a content element, the operating system module 113 may determine whether the content element is stored in the storage 116. Upon determining that the content element is stored in the storage 116, the operating system module 113 may transmit a request to the storage 116 to delete (or remove) the content element stored in the storage 116. In some embodiments, the operating system module 113 may transmit a request for an updated (or current) content element (e.g., an updated credit card balance or a DRM-protected video that includes an image frame depicting the updated credit card balance) to a webpage, application, or portal being executed on the user device 110, or to the application server 125. Upon receiving the updated content element, the operating system module 113 may transmit the updated content element to the storage 116 for storage (or replacement of the invalid content element, if not already deleted).

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc.

In some aspects, the application server 125 may be configured to communicate with the user device 110 and the CDM 130, via the network 120. For example, the application server 125 may be configured to transmit an HTML page (or file) corresponding to a webpage to the browser module 112 or the operating system module 113, via the network 120. In some embodiments, the application server 125 may be configured to receive a notification (or determination) from the browser module 112 that one or more content elements of the HTML page include sensitive information. Further, in some embodiments, the application server 125 may be configured to determine whether one or more content elements of the HTML page (or webpage) include sensitive information. In response to determining (or receiving a determination) that a content element includes sensitive information, the application server 125 may dynamically generate and encrypt a DRM-protected video that includes either (i) a transparent image frame configured to be presented over the sensitive information on the display 117 or (ii) an image frame that depicts or represents the sensitive information. The application server 125 may also be configured to generate and encrypt such a DRM-protected video in response to receiving a request for the DRM-protected video from the user device 110 (e.g., where the user device 110 was unable to locate the DRM-protected video in the storage 116). In some aspects, the application server 125 may be configured to transmit the encrypted, DRM-protected video to the CDM 130 (which may decrypt the encrypted DRM-protected video and transmit the decrypted DRM-protected video to the user device 110).

In some aspects, the application server 125 may be configured to detect an invalid action associated with a content element. For example, in some embodiments, the application server 125 may detect that a content element, such as a credit card balance, is out of date responsive to receiving an indication from an application (e.g., a program, portal, or webpage being executed on the user device 110, the application server 125, or another computing device) that the user 105 recently made a purchase using a credit card associated with the credit card balance. As another example, the application server 125 may detect that a content element (e.g., a credit card balance) stored in the storage 116 warrants deletion after a period of time elapses (e.g., where the period of time may be tracked or measured by a timer associated with a webpage, portal, or application). As yet another example, the application server 125 may detect that a content element (e.g., a credit card balance) stored in the storage 116 warrants deletion when the user 105 logs off (or exits) a webpage, application, or portal being executed on the user device 110. In some embodiments, the application server 125 may be configured to monitor for an invalid action associated with a content element by communicating with (e.g., periodically transmitting an inquiry to and receiving a response from) a webpage, application, or portal being executed on the user device 110, the application server 125, or another computing device.

In some embodiments, in response to detecting an invalid action associated with a content element, the application server 125 may determine whether the content element is stored in the storage 116. Upon determining that the content element is stored in the storage 116, the application server 125 may transmit a request to the storage 116 (e.g., via the operating system module 113 or the browser module 112) to delete (or remove) the content element stored in the storage 116.

In some aspects, the CDM 130 (or DRM platform 130) may be configured to communicate with the user device 110 and the application server 125, via the network 120. For example, the CDM 130 may be configured to receive an encrypted, DRM-protected video from the application server 125. The CDM 130 may also be configured to decrypt the encrypted, DRM-protected video, and transmit the decrypted, DRM-protected video to the user device 110 (e.g., to the browser module 112 or the operating system module 113).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like

Although depicted as separate components in FIG. 1, it should be understood that a component or portion of a component in the environment 100 may, in some embodiments, be integrated with or incorporated into one or more other components. For example, in some embodiments, at least a portion of the application server 125 or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple application servers 125, or multiple CDMs 130.

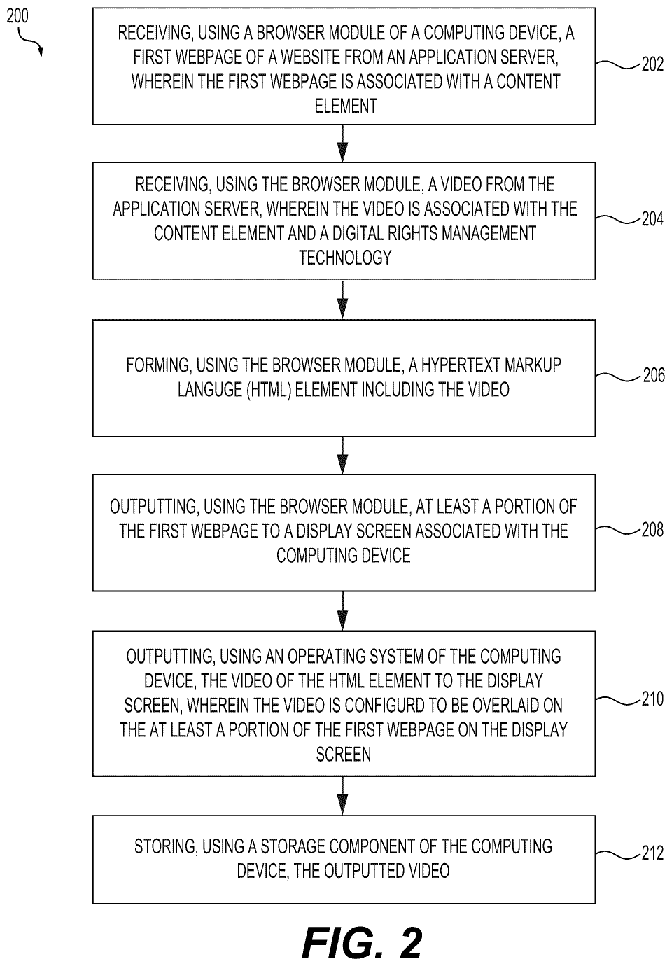

FIG. 2 is a flowchart illustrating a method 200 for securing and storing content of a website (or a webpage, portal, etc.) according to one or more embodiments of the present disclosure. In some aspects, the method 200 may be performed by a computing device (e.g., the user device 110).

As shown in FIG. 2, the method 200 may include receiving, using a browser module (e.g., the browser module 112) of a computing device (e.g., the user device 110), a first webpage of a website from an application server (e.g., the application server 125), where the first webpage is associated with a content element (202). In some embodiments, the first webpage may include the content element, and the content element may include or represent sensitive information (e.g., a credit card balance). In some embodiments, the method 200 may include detecting, using the browser module, that the content element includes sensitive information. The method 200 may further include transmitting, using the browser module, a request to the application server for a video (e.g., associated with the content element and a digital rights management technology) in response to the detection.

The method 200 may include receiving, using the browser module, a video from the application server, where the video is associated with the content element and a digital rights management technology (204). In some aspects, the video may be protected by the digital rights management technology (or be DRM-protected). In some aspects, the video may be configured to be played on a display screen associated with the computing device when the display screen is not screenshared or screenshotted. The video may also be configured to not be played on the display screen when the display screen is being screenshared or screenshotted. Further, in some embodiments, the video may include an image frame that depicts or represents the content element. In some other embodiments, the video may include a transparent image frame (that does not depict or represent the content element).

The method 200 may include forming, using the browser module, a HyperText Markup Language (HTML) element including the video (206). In some aspects, the HTML element may be included in an HTML page corresponding to the first webpage of the website.

The method 200 may include outputting, using the browser module, at least a portion of the first webpage to the display screen associated with the computing device (208). The method 200 may further include outputting, using an operating system (e.g., the operating system module 113) of the computing device, the video of the HTML element to the display screen, where the video is configured to be overlaid on the at least a portion of the first webpage on the display screen (210). In some embodiments, where the content element includes sensitive information (and where the video includes a transparent image frame), the method 200 may further include outputting, using the operating system, the content element to the display screen, where the video is configured to be overlaid on the content element on the display screen, and where the content element is configured to be merged with, or overlaid on (e.g., a background color, design or pattern of), the at least a portion of the first webpage on the display screen.

In some aspects, the method 200 may include storing, using a storage component (e.g., the storage 116) of the computing device, the outputted video (212) (e.g., where the outputted video includes either a transparent image frame or an image frame depicting or representing the content element). Further, where the video includes an image frame that is transparent and where the content element is outputted to the display screen using the operating system, the method 200 may include storing, using the storage component, the outputted content element. In some embodiments, the storage component may include a cache.

In some embodiments, the method 200 may include monitoring, using the browser module, for an invalidation action associated with the content element. The method 200 may further include, detecting, using the browser module, an invalidation action associated with the content element. Detecting the invalidation action associated with the content element may include, for example, detecting that (i) the content element is out of date, (ii) a time period associated with the website has expired, or (iii) a user (e.g., the user 105) associated with the computing device has logged off the website.

In some embodiments, where the video includes an image frame representing the content element, the method 200 may include determining whether the video is stored in the storage component. In response to (i) determining that the video including the image frame representing the content element is stored in the storage component and (ii) detecting the invalidation action associated with the content element, the method 200 may include deleting, using the storage component, the video (e.g., deleting the video from the storage component). Further, where the video includes a transparent image frame (that does not depict the content element), and where the content element has been outputted to the display screen using the operating system, the method 200 may include determining whether the content element is stored in the storage component. In response to (i) determining that the content element is stored in the storage component and (ii) detecting the invalidation action associated with the content element, the method 200 may include deleting, using the storage component, the content element (e.g., deleting the content element from the storage component).

In some embodiments, the method 200 may further include receiving, using the computing device, an indication from a user (e.g., the user 105) that the user wishes to view a second webpage of the website. The indication may include, for example, data representing that the user selected a link on the first webpage of the website, where the link is directed to the second webpage of the website. In some embodiments, the method 200 may include transmitting, using the browser module, a request for the second webpage of the website to the application server. The method 200 may further include receiving, using the browser module of the computing device, the second webpage of the website from the application server (e.g., responsive to transmitting the request for the second webpage). The method 200 may include outputting, using the browser module, at least a portion of the received second webpage to the display screen.

In some embodiments, the method 200 may include receiving, using the computing device, an indication from the user that the user wishes to view (or return to) the first webpage of the website. The method 200 may include retrieving, using the browser module, the first webpage of the website (e.g., from the application server or the storage component) responsive to receiving the indication from the user that the user wishes to return to the first webpage of the website. The method 200 may further include determining that the retrieved first webpage is associated with the content element, where the content element may include sensitive information. The method 200 may include determining, using the browser module, whether the video associated with the content element is stored in the storage component responsive to retrieving the first webpage of the website (or responsive to determining that the retrieved first webpage is associated with the content element). The method 200 may further include, upon determining that the video associated with the content element is stored in the storage component, retrieving, using the browser module, the video associated with the content element from the storage component. The method 200 may include outputting, using the browser module, at least a portion of the retrieved first webpage to the display screen. The method 200 may include outputting, using the operating system, the retrieved video to the display screen, where the retrieved video is configured to be overlaid on the at least a portion of the retrieved first webpage on the display screen.

In some aspects, the method 200 may provide a number of advantages. For example, because the video may be retrieved locally from the storage component of the computing device rather than from the application server, for display once again on the display screen, resources may be conserved. That is, the browser module may not have to request the video from the application server, or receive the video from the application server. Moreover, the video may be rendered, or outputted or loaded to, the display screen more quickly. In addition, because the video is configured to not play on the display screen when the display screen is screenshared or screenshotted, any sensitive information of a content element that is depicted in an image frame of the video, or displayed under a transparent image frame of the video, on the display screen may not be shared with a social engineer or potential social engineer.

While the method 200 described above involves each of a first webpage and a video that are associated with a content element, in some embodiments, each of the first webpage and the video may be associated with multiple content elements (e.g., that include sensitive information). Further, in some embodiments, the second webpage of the method 200 may be associated with one or more content elements (e.g., including sensitive information) and a video associated with the digital rights management technology.

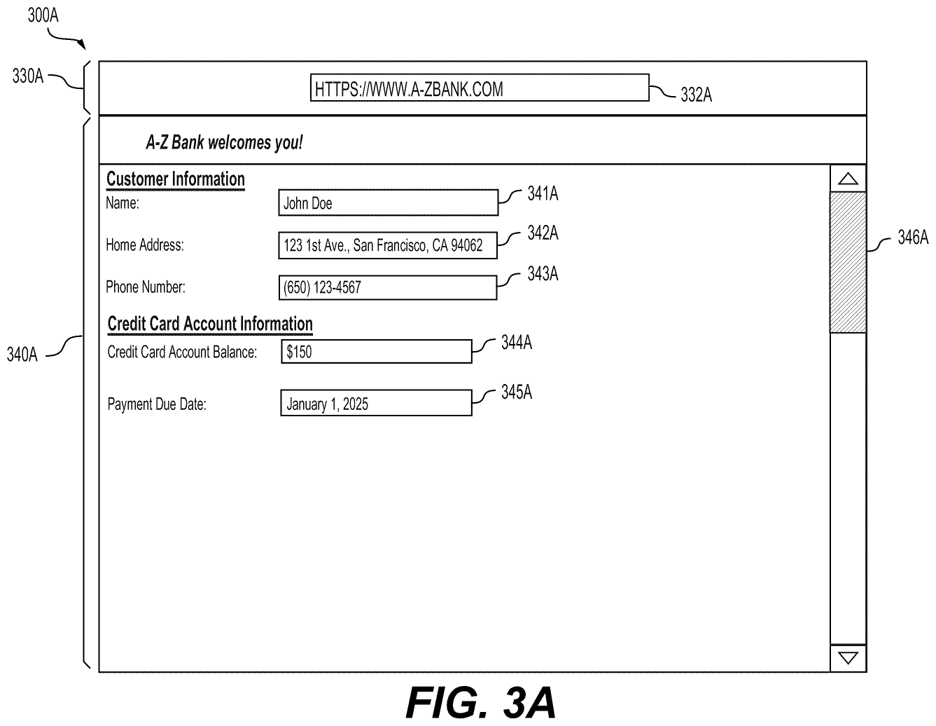

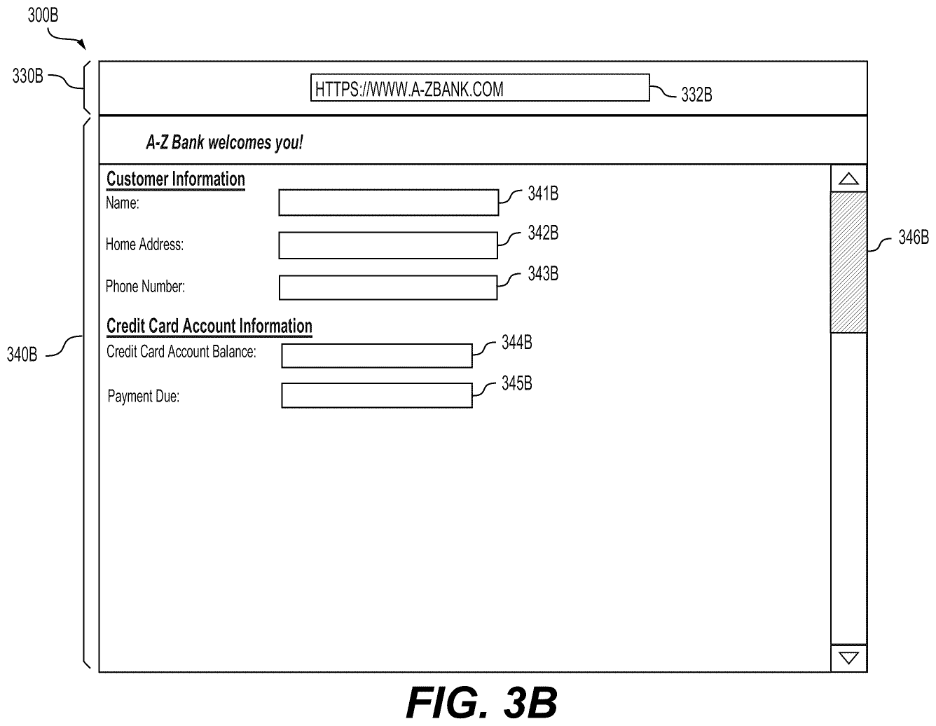

FIG. 3A depicts an example browser window 300A, according to one or more embodiments. More specifically, FIG. 3A shows an example browser window 300A displayed on the display 117 (not shown in FIG. 3A) when the display 117 is not being screenshared or screenshotted. As shown in FIG. 3A, the browser window 300A may include regions 330A and 340A, and a scrollbar 346A. In some aspects, the region 330A and the scrollbar 346A may have been outputted to the display 117 using the browser module 112. The region 340A may have been outputted to the display 117 using the browser module 112 and the operating system module 113.

As shown in FIG. 3A, the region 330A includes a content element 332A, which may represent an address bar (or field) in which the web address (or uniform resource locator), https://www.A-ZBank.com, is entered. In some embodiments, the user 105 may have entered the web address in the content element 332A to view the user 105's credit card balance on a webpage associated with a bank called A-Z Bank.

The region 340A displays a webpage (or at least a portion of a webpage, website, or portal) associated with A-Z Bank. The region 340A is also referred to herein as the “webpage 340A.” In some embodiments, the user 105 may have had to log in to a website associated with A-Z bank in order to view the webpage 340A. As shown in FIG. 3A, the webpage 340A includes content elements such as the greeting, “A-Z Bank welcomes you!” along with customer information and credit card account information. In some aspects, each of the customer information and the credit card account information may be associated with the user 105 (e.g., a person named John Doe).

The customer information may include labels such as Name, Home Address, and Phone Number. The customer information may also include DRM-protected videos 341A, 342A, and 343A, which may correspond to the labels, Name, Home Address, and Phone Number, respectively. In some embodiments, each of the DRM-protected videos 341A, 342A, and 343A may include an image frame that depicts or represents a content element. For example, the DRM-protected video 341A may include an image frame that depicts the name, John Doe; the DRM-protected video 342A may include an image frame that depicts the home address, 123 1st Ave., San Francisco, CA 94062; and the DRM-protected video 343A may include an image frame that depicts the phone number, (650) 123-4567 (where each of the videos 341A-343A is overlaid on, for example, a background color, style, or pattern of the webpage 340A). In some other embodiments, each of the DRM-protected videos 341A, 342A, and 343A may include an image frame that is transparent and overlaid on text data of the webpage 340A. For example, the DRM-protected video 341A may include a transparent image frame that is overlaid on the name, John Doe; the DRM-protected video 342A may include a transparent image frame that is overlaid on the home address, 123 1st Ave., San Francisco, CA 94062; and the DRM-protected video 343A may include a transparent image frame that is overlaid on the phone number, (650) 123-4567.

The credit card account information may include labels such as Credit Card Account Balance and Payment Due Date. The credit card account information may also include DRM-protected videos 344A and 345A, which may correspond to the labels, Credit Card Account Balance and Payment Due Date, respectively. In some embodiments, each of the DRM-protected videos 344A and 345A may include an image frame that depicts or represents a content element of the webpage 340A. For example, the DRM-protected video 344A may include an image frame that depicts a credit card account balance of $150, and the DRM-protected video 345A may include an image frame that depicts a payment due date of Jan. 1, 2025 (where each of the DRM-protected videos 344A and 345A may be overlaid on a background color, pattern or style of the webpage 340A, for example). In some other embodiments, each of the DRM-protected videos 344A and 345A may include an image frame that is transparent and overlaid on a content element of the webpage 340A. For example, the DRM-protected video 344A may include a transparent image frame that is overlaid on the credit card account balance of $150, and the DRM-protected video 345A may include a transparent image frame that is overlaid on the payment due date of Jan. 1, 2025. In some embodiments, each of the DRM-protected videos 341A-345A, and the content elements depicted in or presented under the DRM-protected videos 341A-345A, may have been outputted to the display 117 using the operating system module 113, while the remaining customer information and credit card account information of the webpage 340A may have been outputted to the display 117 using the browser module 112. In some other embodiments, all of the customer information and credit card account information of the webpage 340A may have been outputted to the display 117 using the operating system module 113.

In some aspects, each of the DRM-protected videos 341A-345A may be configured to play when the display 117 is not being screenshared or screenshotted, and to not play when the display 117 is being screenshared or screenshotted. As explained above, because FIG. 3A shows the browser window 300A being displayed on the display 117 when the display 117 is not being screenshared or screenshotted, each of the DRM-protected videos 341A-345A is shown as playing in FIG. 3A. In some embodiments, when each of the DRM-protected videos 341A-345A is played, a respective image frame in each of the DRM-protected videos may be played in a loop. For example, where the DRM-protected video 341A includes an image frame that depicts the name, John Doe, this image frame may be played in a loop when the DRM-protected video 341A is played. As another example, where the DRM-protected video 341A includes a transparent image frame and is overlaid on the name, John Doe, this transparent image frame may be played in a loop when the DRM-protected video 341A is played.

FIG. 3B depicts an example browser window 300B, according to one or more embodiments. More specifically, FIG. 3B shows an example browser window 300B displayed on the display 117 (not shown in FIG. 3B) when the display 117 is being screenshared or screenshotted. In some aspects, the browser window 300B may be an embodiment of the browser window 300A. As shown in FIG. 3B, the browser window 300B may include regions 330B and 340B, and a scrollbar 346B, which may be embodiments of the regions 330A and 340A, and the scrollbar 346A, respectively, of FIG. 3A. The region 330B may include a content element 332B (an address bar), which may be an embodiment of the content element 332A of FIG. 3A. The region 340B may include various content elements such as the greeting, “A-Z Bank welcomes you!” along with customer information and credit card account information. The customer information may include labels and DRM-protected videos 341B, 342B, and 343B, which may be embodiments of the labels and DRM-protected videos 341A, 342A, and 343A, respectively, of FIG. 3A. The credit card account information may include labels and DRM-protected videos 344B and 345B, which may be embodiments of the labels and DRM-protected videos 344A and 344B, respectively, of FIG. 3A.

In some embodiments, each of the DRM-protected videos 341B-345B, and any content elements depicted in or presented under the DRM-protected videos 341B-345B, may have been outputted to the display 117 using the operating system module 113, while the remainder of the webpage 340B may be outputted to the display 117 using the browser module 112. In some other embodiments, all of the customer information and credit card account information of the webpage 340B may have been outputted to the display 117 using the operating system module 113.

Like the DRM-protected videos 341A-345A of FIG. 3A, the DRM-protected videos 341B-345B of FIG. 3B may be configured to play when the display 117 is not being screenshared or screenshotted, and to not play when the display 117 is being screenshared or screenshotted. However, as explained above, because FIG. 3B shows the browser window 300B being displayed on the display 117 when the display 117 is being screenshared or screenshotted, each of the DRM-protected videos 341B-345B is shown as not playing (or as being blocked from playing) in FIG. 3B. Consequently, any content elements associated with (e.g., included in or presented under) the DRM-protected videos 341B-345B are protected from, or not visible to, a social engineer or potential social engineer (and a user such as the user 105) who may view the display 117 or a screenshot of the display 117. It is noted that the type, arrangement, number, and style of content elements (or data) shown in FIGS. 3A and 3B are merely examples.

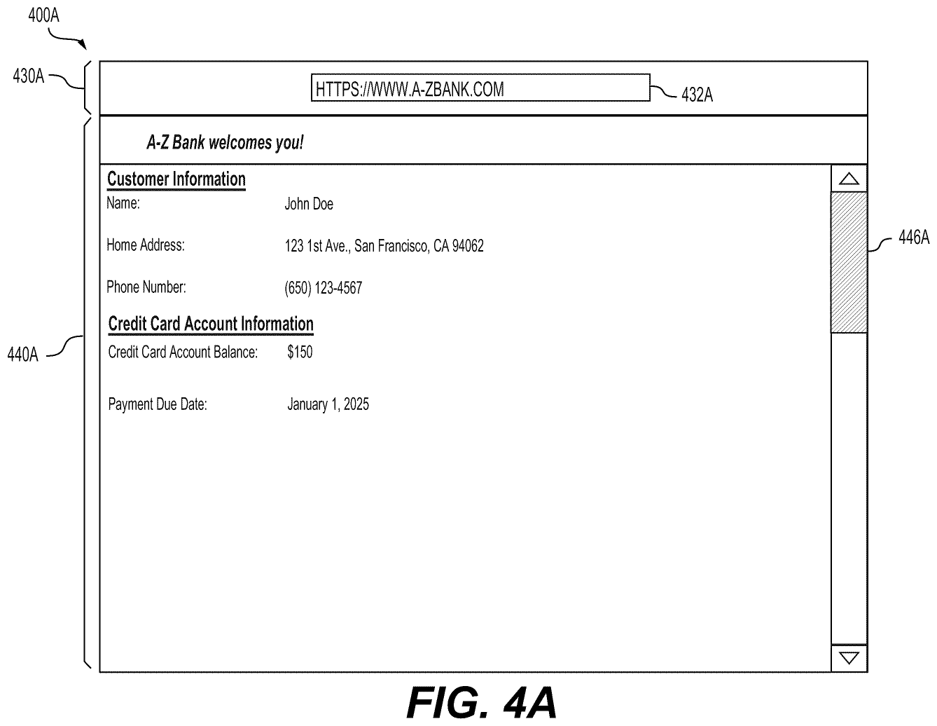

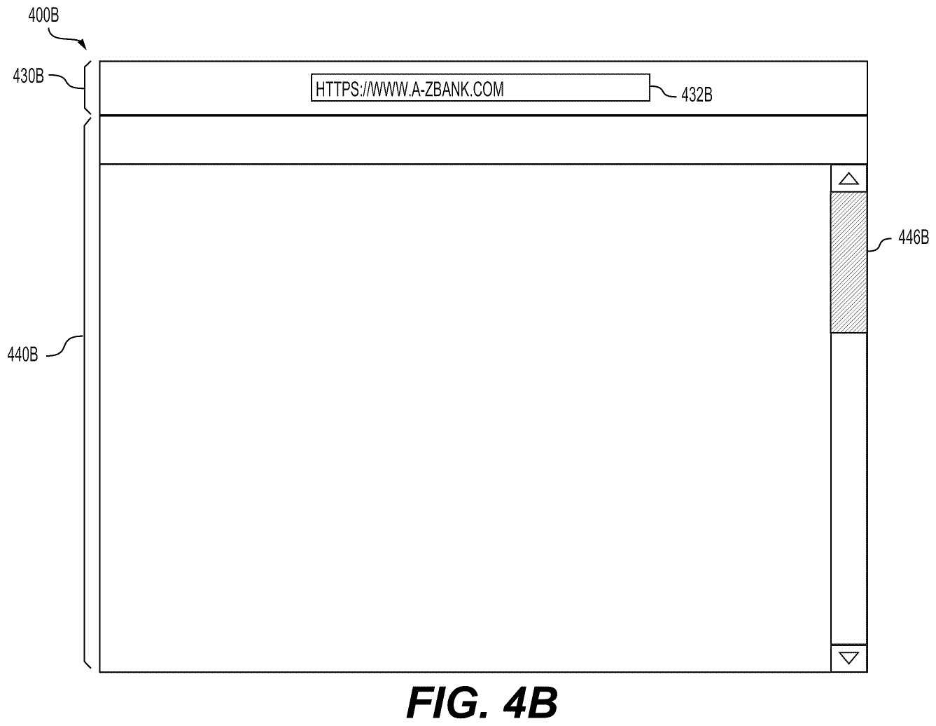

FIG. 4A depicts an example browser window 400A, according to one or more embodiments. More specifically, FIG. 4A shows an example browser window 400A displayed on the display 117 (not shown in FIG. 4A) when the display 117 is not being screenshared or screenshotted. In some aspects, the browser window 400A may be an embodiment of the browser windows 300A and 300B of FIGS. 3A and 3B, respectively.

As shown in FIG. 4A, the browser window 400A may include regions 430A and 440A, and a scrollbar 446A, which may be embodiments of the regions 330A and 340A, and the scrollbar 346A, respectively, of FIG. 3A. The region 430A may include a content element 432A (an address bar), which may be an embodiment of the content element 332A of FIG. 3A. The region 440A (also referred to herein as the “webpage 440A”) may include various content elements such as customer information and credit card account information. The customer information may include the labels, Name, Home Address, and Phone Number. The customer information may also include the information, John Doe, 123 1st Ave., San Francisco, CA 94062, and (650) 123-4567, which may correspond to the Name, Home Address, and Phone Number labels, respectively. The region 440A also includes credit card account information, which may include the labels, Credit Card Account Balance and Payment Due Date. The credit card account information may also include the information, $150 and Jan. 1, 2025, which may correspond to the Credit Card Account Balance and Payment Due Date labels, respectively. In some embodiments, the regions 430A and 440A may have been outputted to the display 117 using the browser module 112 and the operating system module 113, respectively.

Unlike the webpages 340A and 340B of FIGS. 3A and 3B, respectively, the entire webpage 440A is represented by a DRM-protected video (e.g., a video protected using a DRM technology) in FIG. 4A. The webpage 440A may also be referred to herein as the “DRM-protected video 440A.” In some embodiments, the DRM-protected video 440A may include an image frame that depicts all of the content of the webpage 440A (e.g., the greeting, “A-Z Bank welcomes you!,” the customer information, the credit card account information, and the horizontal line separating the greeting from the customer information and the credit card account information), and the DRM-protected video 440A may optionally be overlaid on, for example, a background color, pattern or style of the webpage 440A. In some other embodiments, the DRM-protected video 440A may include a transparent image frame, and be overlaid on the content of the webpage 440A (e.g., the greeting, “A-Z Bank welcomes you!,” the customer information, the credit card account information, and the horizontal line separating the greeting from the customer information and the credit card account information).

In some aspects, the DRM-protected video 440A may be configured to play when the display 117 is not being screenshared or screenshotted, and to not play (or be blocked from playing) when the display 117 is being screenshared or screenshotted. As explained above, because FIG. 4A shows the browser window 400A being displayed on the display 117 when the display 117 is not being screenshared or screenshotted, the DRM-protected video 440A is shown as playing in FIG. 4A. In some aspects, when the DRM-protected video 440A is played, a single image frame of the DRM-protected video 440A may be played in a loop.

FIG. 4B depicts an example browser window 400B, according to one or more embodiments. More specifically, FIG. 4B shows an example browser window 400B displayed on the display 117 (not shown in FIG. 4B) when the display 117 is being screenshared or screenshotted. In some aspects, the browser window 400B may be an embodiment of the browser window 400A. As shown in FIG. 4B, the browser window 400B may include regions 430B and 440B, and a scrollbar 446B, which may be embodiments of the regions 430A and 440A, and the scrollbar 446A, respectively, of FIG. 4A. The region 430B may include a content element 432B (an address bar), which may be an embodiment of the content element 432A of FIG. 4A. In some embodiments, the region 440B (also referred to herein as the “webpage 440B”) may have been outputted to the display 117 using the operating system module 113.

Like the webpage 440A of FIG. 4A, the entire webpage 440B is represented by a DRM-protected video (e.g., a video protected using a DRM technology) in FIG. 4B. The webpage 440B may also be referred to herein as the “DRM-protected video 440B.” Like the DRM-protected video 440A of FIG. 4A, the DRM-protected video 440B of FIG. 4B may be configured to play when the display 117 is not being screenshared or screenshotted, and to not play when the display 117 is being screenshared or screenshotted. However, as explained above, because FIG. 4B shows the browser window 400B being displayed on the display 117 when the display 117 is being screenshared or screenshotted, the DRM-protected video 440B is shown as not playing (or as being blocked from playing) in FIG. 4B. Consequently, any content elements associated with (e.g., included in image frames of or presented under) the DRM-protected video 440B are obfuscated, and thus protected from (or not visible to) a social engineer or potential social engineer (and a user such as the user 105) who may view the display 117 or a screenshot of the display 117. It is noted that the type, arrangement, number, and style of content elements (or data) shown in FIGS. 4A and 4B are merely examples.

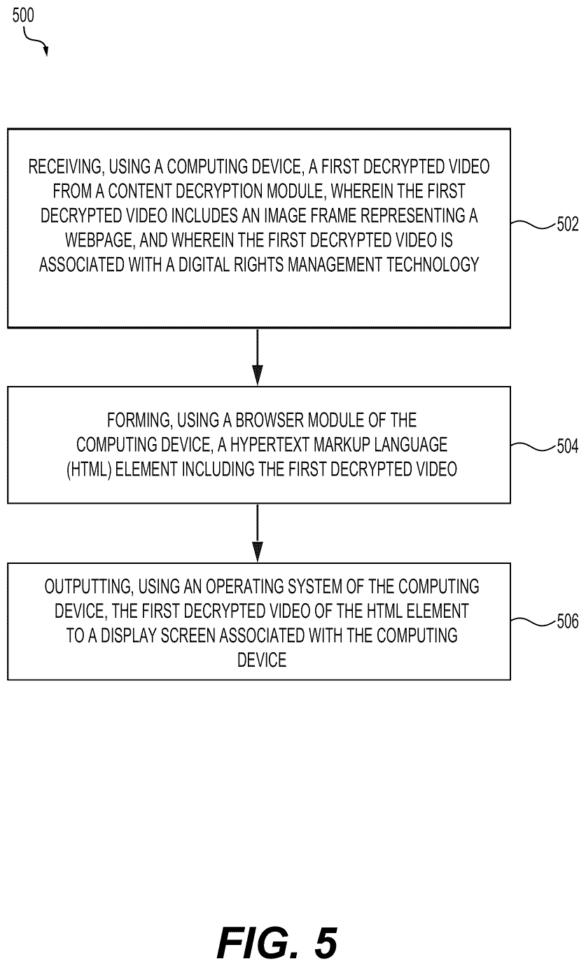

FIG. 5 is a flowchart illustrating a method 500 for securing content of a webpage (or website, web application, portal, etc.), according to one or more embodiments of the present disclosure. The method 500 may be an embodiment of the method 200 of FIG. 2. In some aspects, the method 500 may be performed by a computing device (e.g., the user device 110). Further, the method 500 may be performed dynamically, in real time, or in near real time. In some embodiments, the method 500 may secure all content elements (e.g., all content) of a webpage.

As shown in FIG. 5, the method 500 may include receiving, using a computing device (e.g., the user device 110, the browser module 112, or the operating system module 113), a first decrypted video from a content decryption module (e.g., the CDM 130), where the first decrypted video includes an image frame representing a webpage, and where the first decrypted video is associated with a digital rights management technology (502). In some embodiments, the first decrypted video may be received subsequent (or responsive) to the computing device receiving an indication from a user (e.g., the user 105) that the user wishes to view the webpage. In some aspects, the first decrypted video may be an embodiment of the DRM-protected video 440A or 440B of FIGS. 4A and 4B, respectively. In some aspects, the first decrypted video may be configured to play on a display screen (e.g., the display 117) associated with the computing device when the display screen is not being screenshared or screenshotted. The first decrypted video may also be configured to not play on the display screen when the display screen is being screenshared or screenshotted. In some embodiments, the first decrypted video may include only a single image frame. Further, in some embodiments, the image frame of the first decrypted video may depict or represent all content elements (or the entirety) of the webpage. In some other embodiments, the image frame of the first decrypted video may depict or represent all content elements of the webpage except for content elements representing stylistic features such as background colors or patterns. In such embodiments, the first decrypted video may be configured to be overlaid on, or presented adjacent to, the stylistic features on the display screen, where the stylistic features may be output to the display screen using a browser module (e.g., the browser module 112) and the first decrypted video may be output to the display screen using an operating system module (e.g., the operating system module 113 or the secure display path module 114). In some embodiments, at least one content element of the webpage may include sensitive information.

As shown in FIG. 5, the method 500 may include forming, using a browser module (e.g., the browser module 112) of the computing device, a HyperText Markup Language (HTML) element including the first decrypted video (504). The method 500 may include outputting, using an operating system (e.g., the operating system module 113) of the computing device, the first decrypted video of the HTML element to the display screen associated with the computing device (506). The method 500 may include playing (e.g., in a loop), using the computing device (e.g., the player 115), the first decrypted video outputted to the display screen. In some aspects, during the playing, a user of the computing device may not be able to copy and paste any content elements depicted in the image frame of the first decrypted video. Further, in some embodiments, the method 500 may further include storing, using a storage component (e.g., the storage 116) of the computing device, the first decrypted video that was outputted to the display screen. In some aspects, the storage component may include a cache.

In some embodiments, the webpage may include a content element that is dynamic (also referred to herein as the “dynamic content element”). A dynamic content element may represent a content element that changes over time, such as an animated graphic or a video advertisement. In such embodiments, the first decrypted video may be an initial decrypted video of a plurality of decrypted videos, where each of the plurality of decrypted videos includes only a single image frame that depicts the webpage and a respective version of the dynamic content element. The plurality of decrypted videos may be associated with the digital rights management technology and played sequentially on the display screen. During the playing, a user viewing the display screen may see the webpage and perceive that the dynamic content element is changing on the display screen.

In some other embodiments, the dynamic content element may be associated with a plurality of videos associated with the digital rights management technology, where each of the plurality of videos includes only a single image frame that depicts a respective version of the dynamic content element. While the first decrypted video is played in a loop on the display screen, the plurality of videos may be played sequentially on the display screen, but during the playing, the plurality of videos may be dynamically merged with the first decrypted video. Consequently, when a user views the display screen, the user may see the webpage and perceive that the dynamic content element is changing on the display screen.

In yet some other embodiments, the dynamic content element may be associated with a decrypted video that is associated with the digital rights management technology and includes a plurality of image frames, where each of the plurality of image frames depicts a respective version of the dynamic content element. Such a decrypted video may be played concurrently with the first decrypted video on the display screen, and during the playing, the decrypted video may be dynamically merged with the first decrypted video. As a result, when a user views the display screen, the user may see the webpage and perceive that the dynamic content element is changing on the display screen.

Relative to a method in which only a small number of content elements of a webpage are selected and then protected using a digital rights management technology, the method 500 allows all content elements (or the entirety) of a webpage (or the entirety of a document object model corresponding to the webpage) to be protected using a digital rights management technology. Moreover, the method 500 may be used to prevent one or more content elements depicted in one or more videos from being shared with a social engineer or potential social engineer through screensharing, screenshotting, screen scraping, copying, or pasting. The method 500 may also be used to protect a webpage that includes multiple dynamic content elements. In some aspects, the method 500 may be performed in series with other methods described herein (e.g., the methods 200, 600, 700, or 800 of FIGS. 2, 6, 7, and 8, respectively).

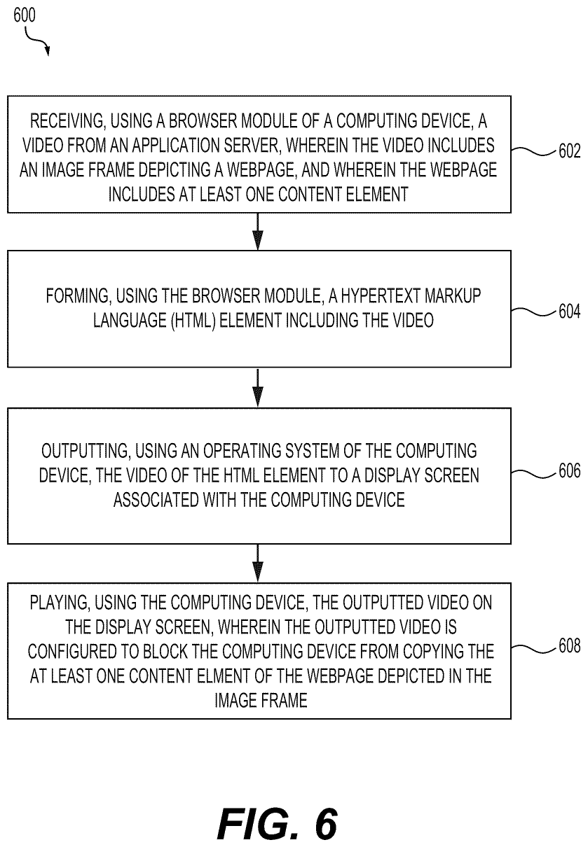

FIG. 6 is a flowchart illustrating a method 600 for securing content of a webpage (or website, web application, portal, etc.), according embodiments of the present disclosure. The method 600 may be an embodiment of the method 200 or 500 of FIGS. 2 and 5, respectively. In some aspects, the method 600 may be performed by a computing device (e.g., the user device 110). Further, in some embodiments, the method 600 may secure content of a webpage by preventing the copying and pasting of one or more content elements included in the webpage, without the use of digital rights management technology.

As shown in FIG. 6, the method 600 may include receiving, using a browser module (e.g., the browser module 112) of a computing device, a video from an application server (e.g., the application server 125), where the video includes an image frame depicting a webpage, and where the webpage includes at least one content element (602). In some embodiments, the at least one content element may include sensitive information. Further, in some embodiments, the video may include only a single image frame. In some aspects, the video may not be associated with a digital rights management technology (or not be DRM-protected).

The method 600 may include forming, using the browser module, a Hyper Text Markup Language (HTML) element including the video (604). In some embodiments, the HTML element may be included in an HTML page corresponding to the webpage. In some embodiments, the method 600 may include outputting, using an operating system (e.g., the operating system module 113) of the computing device, the video of the HTML element on a display screen (e.g., the display 117) associated with the computing device (606). In some other embodiments, the method 600 may include outputting, using the browser module of the computing device, the video of the HTML element on the display screen. The method 600 may also include playing, using the computing device (e.g., the player 115), the outputted video on the display screen, where the outputted video is configured to block the computing device from copying (and pasting) the at least one content element of the webpage depicted in the image frame (608). For example, the video of the HTML element may be configured to prevent the computing device from copying text data or image data included in the webpage to an electronic clip board of the computing device. Accordingly, the method 600 may be used to protect the content of a webpage from a social engineer or potential social engineer using the computing device. In some aspects, where there is a subsequent need to prevent the content of the webpage (or the video) from being screenshared or screenshotted, the video may be retrieved or re-generated, encrypted, and protected using a DRM technology, by the application server. The application server may then transmit, via a CDM (e.g., the CDM 130), such a video to the browser module for subsequent display.

While the video of the method 600 is described above as including an image frame that depicts a webpage, in some embodiments, the video may include an image frame that is transparent and configured to be overlaid on a webpage on the display screen. In such embodiments, the video may not be associated with the digital rights technology but still be configured to prevent the computing system from copying and pasting the video (or the transparent image frame of the video) when the video is played. In some aspects, the method 600 may be performed in series with other methods described herein (e.g., the methods 200, 500, 700, or 800 of FIGS. 2, 5, 7, and 8, respectively).

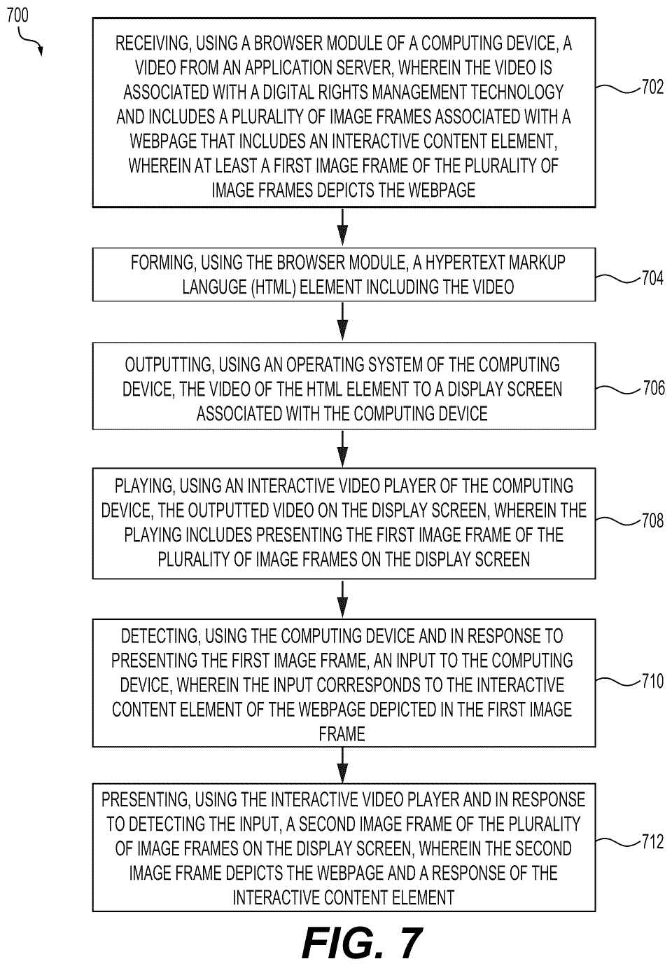

FIG. 7 is a flowchart illustrating a method 700 for securing content of a webpage (or website, web application, portal, etc.), according embodiments of the present disclosure. More specifically, the method 700 may be used to secure content of a webpage (e.g., a portion of the webpage or the entire webpage), where the webpage includes a content element configured to be interactive (also referred to herein as the “interactive content element”). In some aspects, an interactive content element may be a content element configured to respond to an input (e.g., from a user of a computing device). The method 700 may be an embodiment of the method 200, 500, or 600 of FIGS. 2, 5, and 6, respectively. In some aspects, the method 700 may be performed by a computing device (e.g., the user device 110).

As shown in FIG. 7, the method 700 may include receiving, using a browser module (e.g., the browser module 112) of a computing device (e.g., the user device 110), a video from an application server (e.g., the application server 125), where the video is associated with a digital rights management technology and includes a plurality of image frames associated with a webpage that includes an interactive content element, where at least a first image frame of the plurality of image frames depicts the webpage (702). In some embodiments, the video may be received from the application server via a content decryption module (e.g., the CDM 130). Further, the video may be protected by the digital rights management technology (or be DRM-protected). In some embodiments, the webpage may include sensitive information. The interactive content element may represent, for example, a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor).

The method 700 may further include forming, using the browser module, a hypertext markup language (HTML) element including the video (704). The method 700 may include outputting, using an operating system (e.g., the operating system module 113) of the computing device, the video of the HTML element to a display screen (e.g., the display 117) associated with the computing device (706).

In some embodiments, the computing device may include an interactive video player (e.g., the player 115). In some aspects, the interactive video player may be configured to play (e.g. present one or more image frames of) the outputted video on the display screen when the display screen is not being screenshared or screenshotted. The interactive video player may also be configured to not play the outputted video on the display screen when the display screen is being screenshared or screenshotted. In some aspects, the interactive video player may be configured (or customized) to play the outputted video on the display screen and to enable (or support or preserve) the interactivity of the interactive content element during the playing.

As shown in FIG. 7, the method 700 may include playing, using the interactive video player of the computing device, the outputted video on the display screen, where the playing includes presenting the first image frame of the plurality of image frames on the display screen (708) (e.g., when the display screen is not being screenshared or screenshotted). In some aspects, the method 700 may further include presenting, using the computing device and during the playing, a cursor on the display screen, where the cursor may be overlaid on the first image frame. In some embodiments, the cursor may be configured to be presented as a first graphic (e.g., an image) on the display screen when the cursor is concurrently (i) overlaid on the first image frame presented on the display screen and (ii) located at a position that coincides with a position of the interactive content element (of the first image frame) on the display screen. Put differently, the cursor may appear as the first graphic on the display screen when the cursor appears to a user viewing the display screen as being overlaid on the first image frame, and touching (or overlapping) the interactive content element. In some aspects, the first graphic may be an image that indicates that the content element is interactive (e.g., an image of a hand or the letter “I”). Further, in some embodiments, the cursor may be configured to be presented as a second graphic on the display screen when the cursor is concurrently (i) overlaid on the first image frame presented on the display screen and (ii) located at a position that does not coincide with the position of the interactive content element (of the first image frame) on the display screen. Put differently, the cursor may appear as the second graphic on the display screen when the cursor appears to a user viewing the display screen as being overlaid on the first image frame, but not touching (or not overlapping) the interactive content element. The second graphic may represent an image that indicates that the cursor is not positioned over the dynamic content element (or any other dynamic content element included in the first image frame), or that the cursor is in a navigation mode. In some embodiments, the second graphic may be, for example, an image of an arrow. In some aspects, the cursor may be configured in a similar manner when overlaid on any image frame of the plurality of image frames (of the outputted video) presented on the display screen.

The method 700 may include detecting, using the computing device (e.g., the interactive video player) and in response to presenting the first image frame, an input to the computing device, where the input corresponds to (or is associated with) the interactive content element of the webpage depicted in the first image frame (710). In some embodiments, the input may include data representing at least one of: (i) a position of a tap by a finger or stylus on the display screen, where the position of the tap coincides with a position of the interactive content element on the display screen; (ii) a position of a cursor presented on the display screen, where the position of the cursor coincides with a position of the interactive content element on the display screen; (iii) a click of a mouse associated with the computing device; or (iv) a keystroke of a keyboard associated with the computing device. In some embodiments, the method 700 may include tracking, using the computing device (e.g., the interactive video player), a position of the cursor on the display screen relative to the position of the interactive content element displayed on the display screen.

As shown in FIG. 7, the method 700 may further include presenting, using the interactive video player and in response to detecting the input, a second image frame of the plurality of image frames on the display screen, where the second image frame depicts the webpage and a response of the interactive content element (712). In some embodiments, the second image frame may be presented in place of the first image frame on the display screen. In some other embodiments, the second image frame may depict a response of the interactive content element (but not the remainder of the webpage), and be overlaid on the interactive content element of the first image frame. In yet some other embodiments, the second image frame may depict a response of the interactive content element (but not the remainder of the webpage), and be merged (or stitched together) with the first image frame such that the response of the interactive content element replaces the interactive content element depicted in the first image frame. In some aspects, the response of the interactive content element may represent a response that simulates an interaction between a user (e.g., using a cursor, stylus, or finger to provide the input) and the interactive content element. For example, where the interactive content element represents a button, the response of the interactive content element may include an image of the button being selected or depressed, or an image of the button with a drop down menu appearing below the button. In some embodiments, the method 700 may include presenting, using the interactive video player and in response to presenting the second image frame, multiple other image frames of the plurality of image frames, where the multiple other image frames may, when presented (or played) in sequence, appear to the user as an animated response of the interactive content element to the detected input.

While the method 700 is described above as securing a webpage that includes an interactive content element, in some embodiments, the method 700 may be used to secure a webpage that includes multiple interactive content elements (while enabling or preserving the interactivity of the multiple interactive content elements). Further, while the method 700 is described above as securing a video that includes a plurality of image frames, in some embodiments, the method 700 may be used to secure a video that includes a single image frame, or multiple videos, where each of the multiple videos includes one or more image frames. Accordingly, the method 700 may be used to secure digital content from a social engineer or potential social engineer, while preserving the interactivity of one or more interactive content elements included in the digital content.

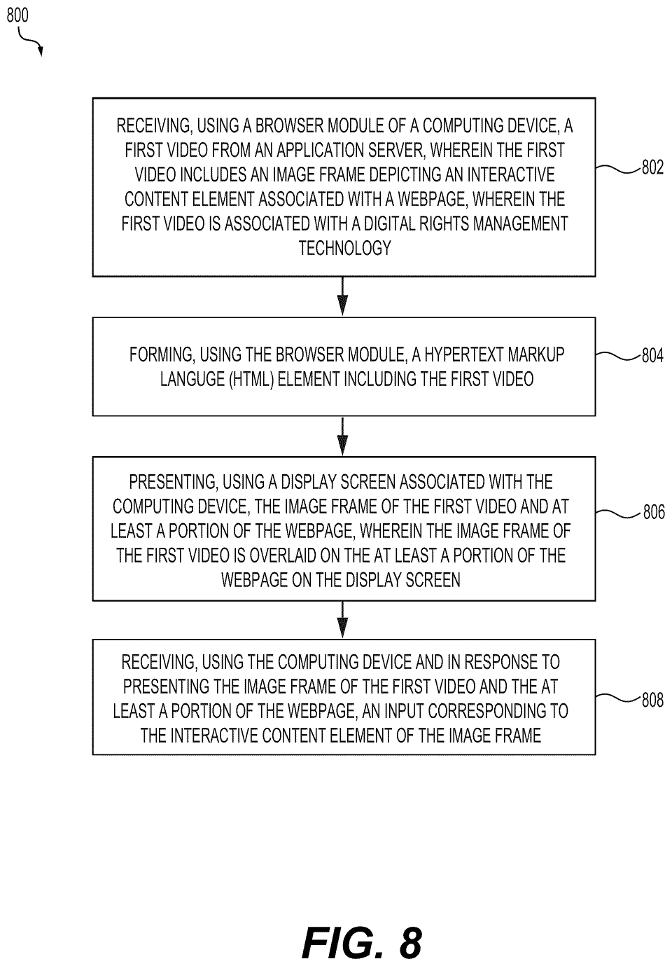

FIG. 8 is a flowchart illustrating a method 800 for securing content of a webpage (or website, web application, portal, etc.), according embodiments of the present disclosure. More specifically, the method 800 may be used to secure content of a webpage (e.g., a portion of the webpage or the entire webpage), where the webpage includes an interactive content element. The method 800 may be an embodiment of the method 200, 500, 600, or 700 of FIGS. 2, 5, 6, and 7, respectively. In some aspects, the method 800 may be performed by a computing device (e.g., the user device 110).

As shown in FIG. 8, the method 800 may include receiving, using a browser module (e.g., the browser module 112) of a computing device (e.g., the user device 110), a first video from an application server (e.g., the application server 125), where the first video includes an image frame depicting an interactive content element associated with a webpage, and where the first video is associated with a digital rights management technology (802). In some aspects, the interactive content element may be included in the webpage. In some embodiments, the first video may be received from the application server via a content decryption module (e.g., the CDM 130). Further, the first video may be protected by the digital rights management technology (or be DRM-protected). In some embodiments, the first video may be configured to play the image frame depicting the interactive content element in a loop. Further, in some embodiments, the interactive content element or the webpage may include sensitive information. Further, the interactive content element may represent, for example, a button, a toggle switch, a text box, a link (e.g., a hyperlink), an icon that may be selected to launch an application, text that may be highlighted or selected (e.g., using a cursor), or one or more images that may be highlighted or selected (e.g., using a cursor).

The method 800 may further include forming, using the browser module, a hypertext markup language (HTML) element including the first video (804). In some embodiments, the HTML element including the first video may be included in an HTML page representing the webpage. In some embodiments, the method 800 may include outputting, using the computing device, at least a portion of the webpage and the first video of the HTML element, to a display screen (e.g., the display 117) associated with the computing device (804). More specifically, in some embodiments, the browser module may be used to output the at least a portion of the webpage to the display screen, and an operating system (e.g., the operating system module 113) of the computing device may be used to output the first video to the display screen. In some aspects, the outputted first video may be configured to play (e.g., present the image frame depicting the interactive content element) on the display screen when the display screen is not being screenshared or screenshotted. The outputted first video may also be configured to not play (e.g., not present the image frame depicting the interactive content element) on the display screen when the display screen is being screenshared or screenshotted.

In some embodiments, the method 800 may include playing, using the computing device (e.g., the player 115), the outputted video on the display screen, where the outputted video may be overlaid on the outputted at least a portion of the webpage on the display screen during the playing. More specifically, the method 800 may include presenting, using the display screen associated with the computing device, the image frame of the first video and the at least a portion of the webpage, where the image frame of the first video is overlaid on the at least a portion of the webpage on the display screen (806) (e.g., when the display screen is not being screenshared or screenshotted). In some embodiments, the image frame of the first video may be overlaid on a background color (or background design or pattern) of the at least a portion of the webpage presented on the display screen. In some other embodiments, the image frame of the first video may be overlaid on another version (or graphic) of the interactive content element included in the at least a portion of the webpage presented on the display screen.

The method 800 may include receiving (or detecting or capturing), using the computing device and in response to presenting the image frame of the first video and the at least a portion of the webpage, an input corresponding to the interactive content element of the image frame (808). In some embodiments, a transparent layer may be presented over the image frame of first video (and the at least a portion of the webpage) on the display screen, and be used to detect the input corresponding to the interactive content element. In some aspects, the input may include data representing at least one of: (i) a position of a tap by a finger or stylus on the display screen, where the position of the tap coincides with a position of the interactive content element on the display screen; (ii) a position of a cursor presented on the display screen, where the position of the cursor coincides with a position of the interactive content element on the display screen; (iii) a click of a mouse associated with the computing device; or (iv) a keystroke of a keyboard associated with the computing device. In some embodiments, the computing device may be configured to transmit the input (e.g., data representing the input) to another version (or graphic) of the interactive content element presented under the first video in order to trigger a response from this interactive content element. In some other embodiments, the computing device may be configured to transmit the input (e.g., data representing the input) to another version (or graphic) of the interactive content element generated or rendered but not displayed on the display screen in order to trigger a response from this interactive content element.

Further, in some embodiments, the method 800 may include, in response to receiving the input corresponding to the interactive content element, presenting, using the display screen, an image frame of a second video in place of the image frame of the first video, where the image frame of the second video is overlaid on the at least a portion of the webpage on the display screen. The second video may be associated with the digital rights management technology and depict a response of the interactive content element to the received input. The response of the interactive content element may represent a response that simulates an interaction between a user (e.g., using a cursor, stylus, or finger to provide the input) and the interactive content element. Further, subsequent to presenting the image frame of the second video, the method 800 may include presenting (e.g., in sequence) multiple other image frames of one or more videos associated with the digital rights management technology, in place of the image frame of the second video. In some aspects, each image frame of the multiple other image frames may depict a respective version of the response of the interactive content element, and when played on the display screen, be overlaid on the at least a portion of the webpage also presented on the display screen. Consequently, when the multiple other image frames are presented (or played) in sequence on the display screen, a user viewing the display screen may perceive the multiple other image frames as an animated response of the interactive content element to the detected input.

In some embodiments, where the interactive content element (of the image frame of the first video) represents a text box, the input received by the computing device may include data representing a first keystroke. The first key stroke may represent a depression of a key (or the sequential or concurrent depression of multiple keys) of a keyboard associated with the computing device. Further, the first keystroke may represent a letter, number, or symbol. In some embodiments, the text box may be depicted in the image frame of the first video (and presented on the display screen) as, for example, a white rectangle that has four black lines used to depict the left side, right side, top side, and bottom side, respectively, of the white rectangle. In response to the computing system receiving (or detecting) the first keystroke (or input), which may correspond to the symbol, “$,” for example, the display screen may present an image frame of a video that is associated with the first keystroke and the digital rights management technology. For example, the image frame (of the video associated with the first keystroke) may depict the symbol, “$,” optionally with black lines on the bottom, left side, and top of the symbol, “$,” where the black lines may correspond to portions of the rim at (or near) the left side of the white text box. In such an embodiment, the image frame (of the video associated with the first keystroke) may be overlaid on, or merged (e.g., stitched together) with, the image frame of the first video (depicting the white text box with the black rim) presented on the display screen. In some aspects, the video associated with the first keystroke may be dynamically generated (e.g., via the application server 125) in response to the computing system receiving (or detecting) the first keystroke. Alternatively, the video associated with the first keystroke may be pre-generated (e.g., via the application server 125) and pre-loaded to the display screen (e.g., before the computing system detected the first keystroke).

In some embodiments, the computing system may receive (or detect) a second keystroke (e.g., after receiving the first keystroke), and the display screen may subsequently present an image frame of a video that is associated with the second keystroke and the digital rights management technology. The image frame of the video associated with the second keystroke may depict, for example, the number “5,” optionally with black lines below and above the number “5,” where the black lines may correspond to portions of the black rim of the white text box. In such an embodiment, the image frame of the video associated with the second keystroke may be presented to the right of (or adjacent to), and optionally be merged with, the image frame of the video associated with the first keystroke (depicting “$,” optionally with black lines below, to the left, and above the symbol, “$”). The image frame of the video associated with the second keystroke (depicting “5,” optionally with black lines below and above the “5”) may also be overlaid on the image frame of the first video (depicting the white text box with a black rim), which may be overlaid on the at least a portion of the webpage on the display screen. Consequently, a user viewing the display screen may see a webpage that indicates “$5” in a white text box with a black rim.

In some aspects, the video associated with the second keystroke may be dynamically generated (e.g., via the application server 125) in response to the computing system detecting the second keystroke. Alternatively, the video associated with the second keystroke may be pre-generated (e.g., via the application server 125) and pre-loaded to the display screen (e.g., before the computing system detects the second keystroke). Further, in some embodiments, a plurality of videos associated with the digital rights management technology may be pre-generated and pre-loaded to the display screen (e.g., before the computing system detects any keystrokes associated with the white text box with the black rim), where each of the plurality of videos may include an image frame that represents a respective letter, number, or symbol that could be presented in the white text box with the black rim.

While the method 800 is described above as securing a webpage that includes an interactive content element, in some embodiments, the method 800 may be used to secure a webpage that includes multiple interactive content elements. Accordingly, the method 800 may be used to protect digital content from a social engineer or potential social engineer, while preserving the interactivity of one or more interactive content elements included in the digital content.

In general, any process or operation discussed in this disclosure that is understood to be computer-implementable, such as the processes (or methods) illustrated in FIGS. 2 and 5-8, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

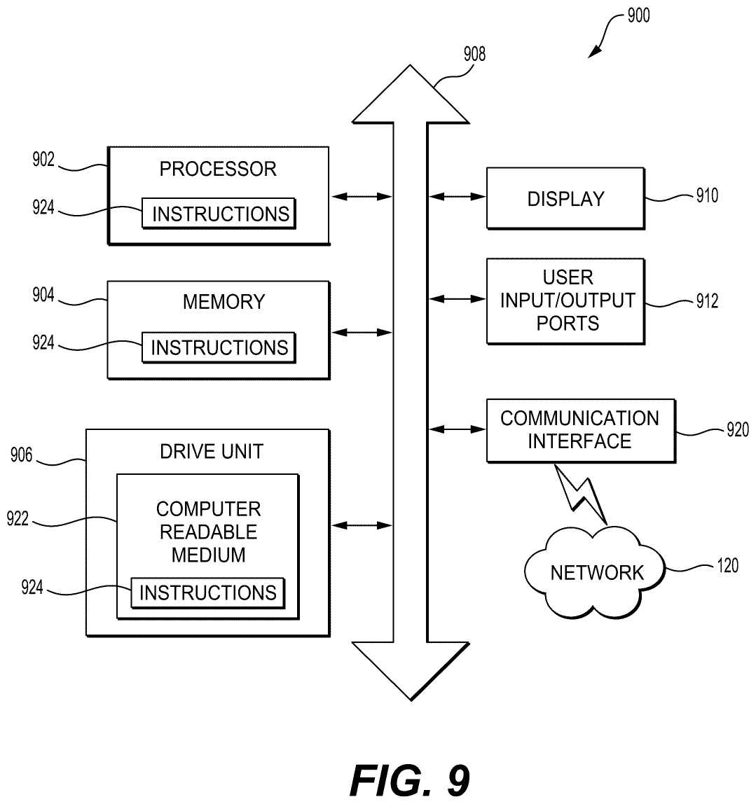

FIG. 9 is a simplified functional block diagram of a computer 900 that may be configured as a device for executing the methods of FIG. 2, 5, 6, 7, or 8, according to exemplary embodiments of the present disclosure. For example, in some embodiments, the computer 900 may be configured as the user device 110, according to exemplary embodiments of this disclosure. In some other embodiments, the computer 900 may be configured as the application server 125, according to exemplary embodiments of this disclosure. In some other embodiments, the computer 900 may be configured as the CDM 130, according to exemplary embodiments of this disclosure. In various embodiments, any of the devices or systems herein may be a computer 900 including, for example, a data communication interface 920 for packet data communication. The computer 900 also may include a central processing unit (“CPU”) 902, in the form of one or more processors, for executing program instructions. The computer 900 may include an internal communication bus 908, and a storage (or drive) unit 906 (such as ROM, HDD, SDD, etc.) that may store data on a computer readable medium 922, although the computer 900 may receive programming and data via network communications. The computer 900 may also have a memory 904 (such as RAM) storing instructions 924 for executing techniques presented herein, although the instructions 924 may be stored temporarily or permanently within other modules of computer 900 (e.g., processor 902 or computer readable medium 922). The computer 900 also may include input and output ports 912 or a display (or display screen) 910 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a browser module of a computing device, a first webpage of a website from an application server, wherein the first webpage is associated with a content element;
receiving, using the browser module, a video from the application server, wherein the video is associated with the content element and a digital rights management technology;
forming, using the browser module, a HyperText Markup Language (HTML) element including the video;
outputting, using the browser module, at least a portion of the first webpage to a display screen associated with the computing device;
outputting, using an operating system of the computing device, the video of the HTML element to the display screen, wherein the video is configured to be overlaid on the at least a portion of the first webpage on the display screen; and
storing, using a storage component of the computing device, the outputted video.

2. The method of claim 1, wherein the video includes an image frame representing the content element, and wherein the content element represents sensitive information.

3. The method of claim 1, wherein the video includes a transparent image frame and the content element includes sensitive information, and wherein the method further comprises:
outputting, using the operating system of the computing device, the content element to the display screen, wherein the video is configured to be overlaid on the content element on the display screen, and wherein the content element is configured to be merged with, or overlaid on, the at least a portion of the first webpage on the display screen; and
storing, using the storage component, the outputted content element.

4. The method of claim 1, wherein the storage component includes a cache.

5. The method of claim 1, further comprising:
detecting, using the browser module, an invalidation action associated with the content element.

6. The method of claim 5, wherein the video includes an image frame representing the content element, and wherein the method further comprises:
deleting, using the storage component, the video in response to detecting the invalidation action.

7. The method of claim 5, wherein the video includes a transparent image frame and the content element includes sensitive information, and wherein the method further comprises:
outputting, using the operating system of the computing device, the content element to the display screen, wherein the video is configured to be overlaid on the content element on the display screen, and wherein the content element is configured to be merged with, or overlaid on, the at least a portion of the first webpage on the display screen;
storing, using the storage component, the content element prior to detecting the invalidation action associated with the content element; and
deleting, using the storage component, the content element in response to detecting the invalidation action.

8. The method of claim 5, wherein detecting, using the browser module, the invalidation action associated with the content element comprises:
detecting that the content element is out of date;
detecting that a time period associated with the website has expired; or
detecting that a user associated with the computing device has logged off the website.

9. The method of claim 1, further comprising:
monitoring, using the browser module, for an invalidation action associated with the content element.

10. The method of claim 1, further comprising:
outputting, using the browser module, at least a portion of a second webpage of the website to the display screen subsequent to outputting the video of the HTML element to the display screen;
retrieving, using the browser module, the first webpage of the website subsequent to outputting the at least a portion of the second webpage of the website to the display screen;
determining, using the browser module, whether the video associated with the content element is stored in the storage component responsive to retrieving the first webpage of the website;
upon determining that the video associated with the content element is stored in the storage component, retrieving, using the browser module, the video associated with the content element from the storage component;
outputting, using the browser module, at least a portion of the retrieved first webpage to the display screen; and
outputting, using the operating system, the retrieved video to the display screen, wherein the retrieved video is configured to be overlaid on the at least a portion of the retrieved first webpage on the display screen.

11. A system comprising:
at least one processor; and
at least one memory having programming instructions stored thereon, which, when executed by the at least one processor, cause the system to perform operations comprising:
receiving, using a browser module of a computing device, a first webpage of a website, wherein the first webpage is associated with a content element;
receiving, using the browser module, a video associated with the content element and a digital rights management technology;
forming, using the browser module, a HyperText Markup Language (HTML) element including the video;
outputting, using the browser module, at least a portion of the first webpage to a display screen associated with the computing device;
outputting, using an operating system of the computing device, the video of the HTML element to the display screen, wherein the video is configured to be overlaid on the at least a portion of the first webpage on the display screen; and
storing, using a storage component of the computing device, the outputted video.

12. The system of claim 11, wherein the video includes an image frame representing the content element, and wherein the content element represents sensitive information.

13. The system of claim 11, wherein the video includes a transparent image frame and the content element includes sensitive information, and wherein the operations further comprise:
outputting, using the operating system of the computing device, the content element to the display screen, wherein the video is configured to be overlaid on the content element on the display screen, and wherein the content element is configured to be merged with, or overlaid on, the at least a portion of the first webpage on the display screen; and
storing, using the storage component, the outputted content element.

14. The system of claim 11, wherein the storage component includes a cache.

15. The system of claim 11, wherein the operations further comprise:
detecting, using the browser module, an invalidation action associated with the content element.

16. The system of claim 15, wherein the video includes an image frame representing the content element, and wherein the operations further comprise:
deleting, using the storage component, the video in response to detecting the invalidation action.

17. The system of claim 15, wherein the video includes a transparent image frame and the content element includes sensitive information, and wherein the operations further comprise:
outputting, using the operating system of the computing device, the content element to the display screen, wherein the video is configured to be overlaid on the content element on the display screen, and wherein the content element is configured to be merged with, or overlaid on, the at least a portion of the first webpage on the display screen;
storing, using the storage component, the content element prior to detecting the invalidation action associated with the content element; and
deleting, using the storage component, the content element in response to detecting the invalidation action.

18. The system of claim 15, wherein detecting, using the browser module, the invalidation action associated with the content element comprises:
detecting that the content element is out of date;
detecting that a time period associated with the website has expired; or
detecting that a user associated with the computing device has logged off the website.

19. The system of claim 11, wherein the operations further comprise:
receiving, using the browser module, a video associated with the content element but not the digital rights management technology, wherein the video is configured to block the computing device from copying the content element when the video is played on the display screen.

20. A method comprising:
receiving, using a browser module of a computing device, a first webpage of a website, wherein the first webpage is associated with a content element;
receiving, using the browser module, a video associated with a digital rights management technology and including an image frame that represents the content element;
forming, using the browser module, a HyperText Markup Language (HTML) element including the video;
outputting, using the browser module, at least a portion of the first webpage to a display screen associated with the computing device;
outputting, using an operating system of the computing device, the video of the HTML element to the display screen, wherein the video is configured to be overlaid on the at least a portion of the first webpage on the display screen; and
storing, using a cache of the computing device, the outputted video.
